(19) United States
(12) Patent Application Publication
(10) Pub. No.: US 2011/0304824 A1
(43) Pub. Date: Dec. 15, 2011

(54) SCREEN

(76) Inventors: Thomas Franz Lechner, Wien (AT); David Gabriel Lechner, Wien (AT); Gregor Sebastian Lechner, Wien (AT)

(21) Appl. No.: 13/203,043

(22) PCT Filed: Feb. 18, 2010
(86) PCT No.: PCT/AT2010/000045

§ 371 Date: Aug. 24, 2011

(30) Foreign Application Priority Data
Feb. 24, 2009 (AT) A 304/2009

(51) Int. Cl. G03B 21/28; G03B 31/00

(52) U.S. Cl. 353/15; 359/449; 353/97; 353/98; 353/69

(57) ABSTRACT

A screen having a display angle of 360°, wherein in the light path of a projection means and in the area of the central axis of a projection surface closed about 360° formed by a pillar a mirror is located, wherein the mirror is configured as a spherical mirror.

The present invention relates to a screen having a display angle of 360°.

It is well known to provide a cylinder surface across the entire circumference with a matrix of LEDs and to drive them electronically so that at sufficient viewer distance the individual illuminated points complement each other to digit-like or shape-like images. It is a disadvantage of this solution that the image resolution is limited by the size of the LEDs, that only a limited colour range is available, and that the desired display content has to be converted into a particular electronic format.

U.S. Pat. No. 5,818,401 discloses a screen consisting of LED rows rotating in a drum. The level of the rotational speed, as well as the LED control, are selected such that for the viewer by utilization of the human visual inertia a stationary cylindrical screen surface having the desired display contents is created. Additionally to the disadvantages stated for this teaching rotating mechanics are required resulting in higher maintenance and repair costs. It is another disadvantage that only rotationally symmetric screen surfaces may be produced.

The invention is directed to create a screen having a display angle of 360°, which allows for a high resolution and includes no movable parts. It is another goal of the invention to create a screen that is easy to construct, is not only limited to rotationally symmetrical screen surfaces, and is able to display electronic standard formats of graphics, photographs, or films.

It is another goal to create an advertising means equipped with a screen upon which contents may be shown multimedia based.

The inventive screen is characterized in that in the light path of a projection means and in the area of the central axis of a projection surface closed about 360° formed by a pillar, a mirror is located, the latter being configured as a spherical mirror.

In an alternative embodiment, the screen is characterized in that in the light path of a projection means and in the area of the central axis of a projection surface closed about 360° formed by a pillar, a mirror is located, the mirror surface of which is the surface of a curve rotating about the axis located in the light path of the projection means, wherein the curve and the distance of the projection means to the mirror are chosen in such a way that the screen upon projection of the mirror is illuminated at an angle of 360°.

A preferred embodiment of the screen is characterized in that the spherical mirror is spherical, parabolic, or hyperbolic. It may also be configured elliptically.

In another preferred embodiment, the mirror is open in the area of the rotational axis.

In another preferred embodiment a diaphragm element is arranged in the light path between the projection means and the mirror.

In another preferred embodiment, the diaphragm element is configured as a cable duct.

In another preferred embodiment the projection means is at least one projector.

An additional embodiment has the feature that the pillar and the projection surface are essentially configured cylindrically or ellipsoidally.

A preferred embodiment of the screen is characterized in that the projection surface is a back projection foil, which is made of polyvinylchloride, for example.

In another preferred embodiment an essentially plane mirror is located in the light path of the projection means and the mirror is arranged such that the light reflected from the plane mirror is reflectable through it onto the projection surface again.

Another preferred embodiment of the invention is characterized in that the projection means is driveable by a computer, wherein a program for processing the image data is installed on the computer through which the display distorted by the mirror curvature is rectifiable.

An object of the invention is also a pillar, in particular an advertising pillar, having a screen according to the previously described configuration.

A preferred embodiment of the pillar comprises that the projection means includes two projectors and in the area viewed from the projection means speakers for audio playback are located behind the mirror, wherein cables for driving the speakers are routed in the central axis of the pillar and in the diaphragm element.

Another preferred embodiment of the pillar comprises that it presents a second screen, wherein the associated projection means and the associated mirror of the second screen are arranged in opposition to those of the first screen. According to a preferred embodiment the projection surface is essentially spherical or cone shaped.

Another object of the invention is a pillar, in particular an advertising pillar, having a cylindrical pillar body, that provides a projection surface for messages, characterized in that in the pillar body there is provided a projection means, in the light path of which and in the area of the central axis of the projection surface closed about 360° a mirror is located.

The inventive pillar is characterized in that a projection means is provided in the pillar body, wherein in the light path of it and within the area of the central axis of the projection surface closed about 360° a mirror is located.

In the following the invention will be described in more detail with reference to an exemplary embodiment depicted in the accompanying drawings, wherein:

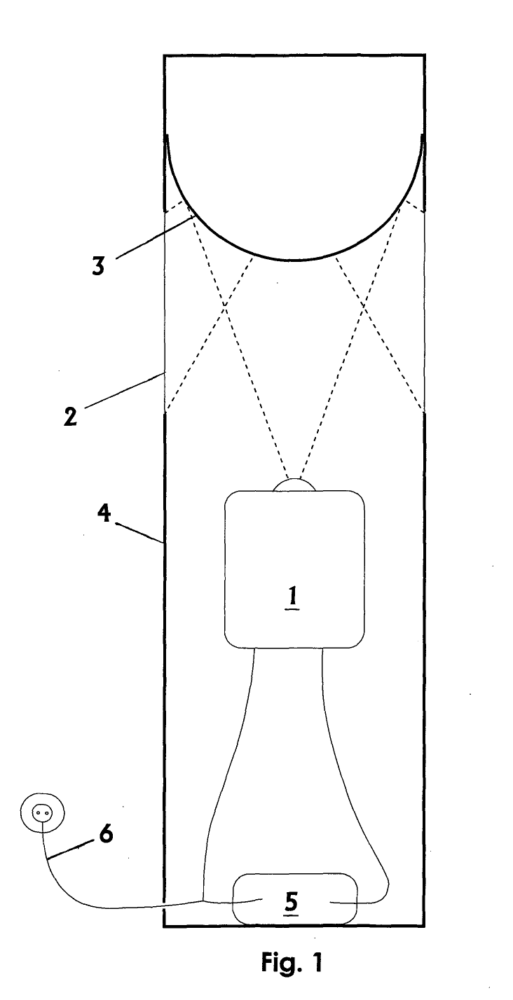

FIG. 1 shows a sectional view through a screen installed in a pillar;

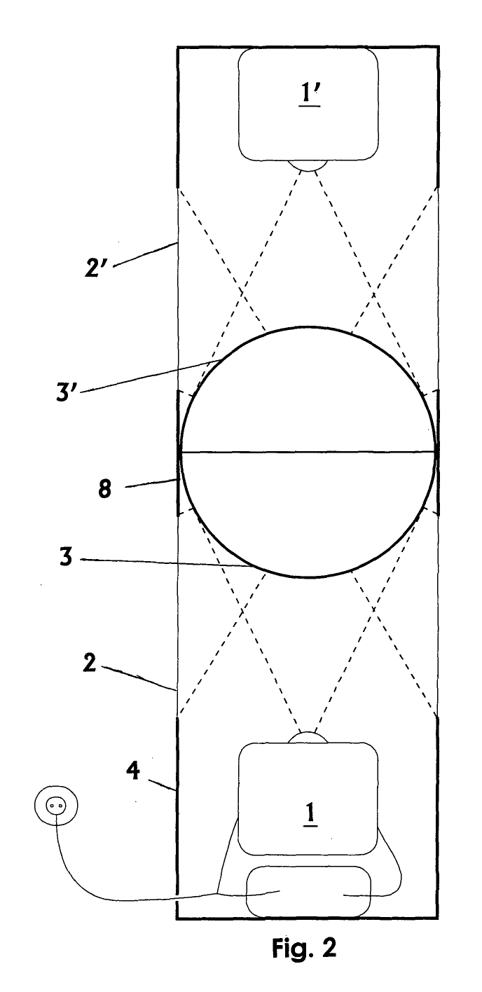

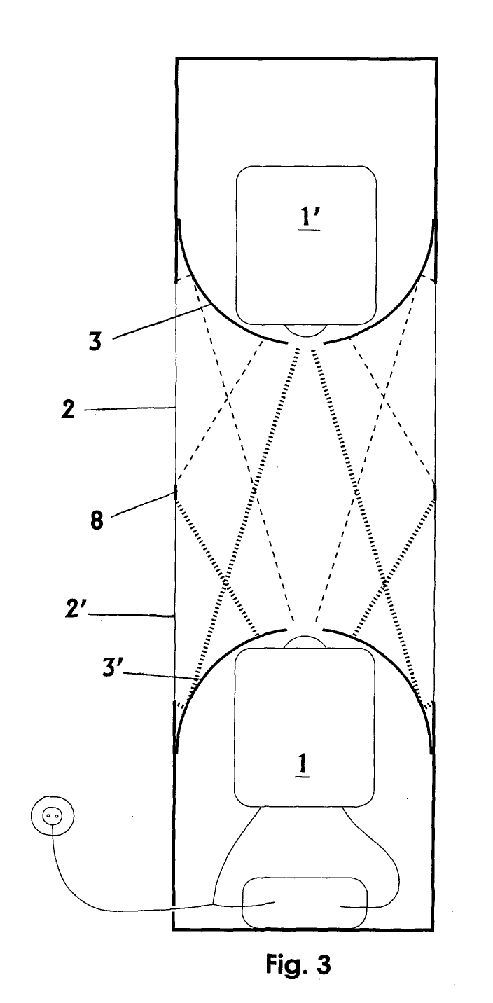

FIG. 2 and FIG. 3 each show sectional views through two screens installed in a pillar;

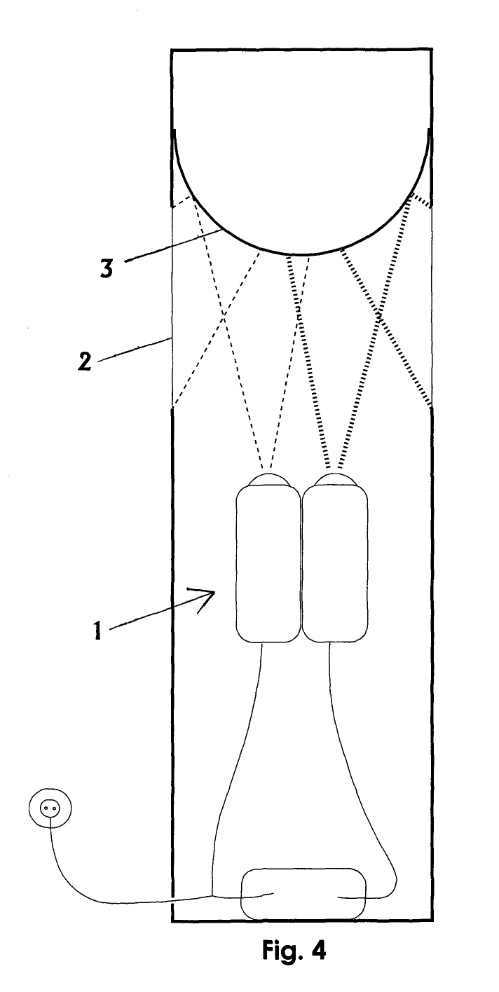

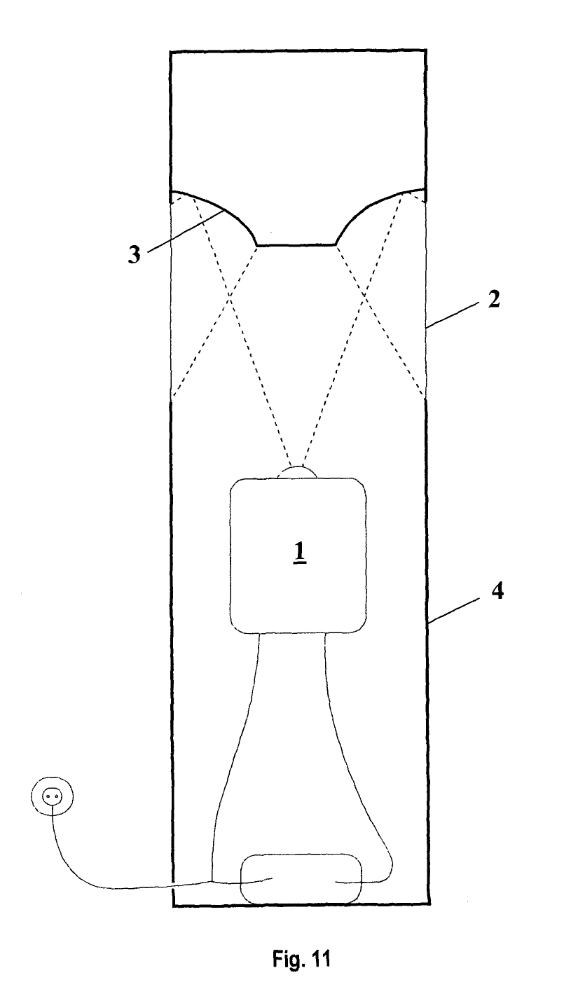

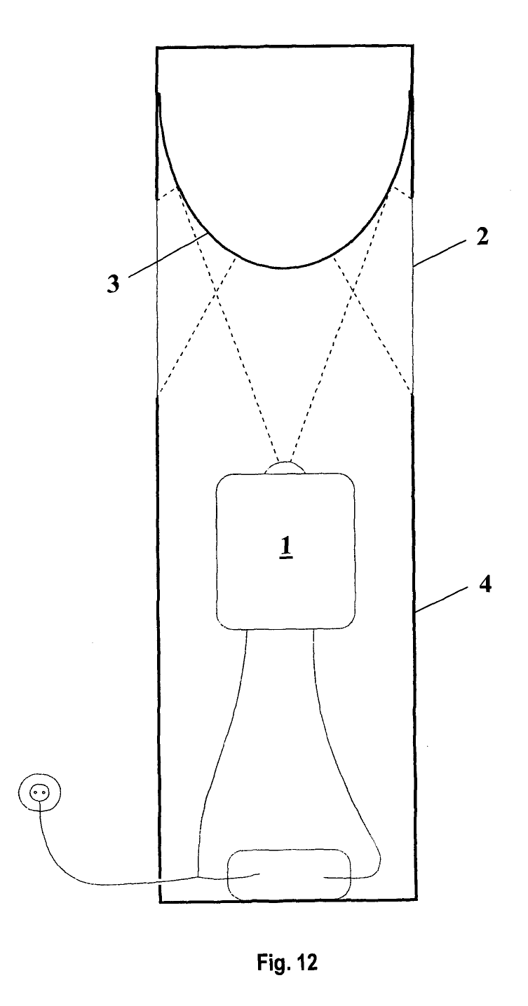

FIG. 4 to FIG. 15 each show sectional views through a screen built into a pillar.

According to FIG. 1, a mirror 3 is placed opposite a projection means 1, which reflects light onto a projection surface 2, which forms a section of a cylindrical pillar 4 receiving the projection means, the mirror and a driving device 5 for the projection means. Preferably, the axis of rotation of the mirror is located near or within the central optical axis, which is determined by the projection means 1. Preferably, also the axis of rotation of the two-dimensional, projection surface 2 extending about 360° is located near or within the central optical axis, which is indicated by the projection means 1. The projection means 1 may be a commercially available projector, which is driven by a computer 5 forming the driving device. A commercially available playback device, e.g. a blue ray player, DVD player etc. can be used as driving device. The projection means may further consist of two or more projectors, which present different contents or a common content in higher resolution or higher brightness.

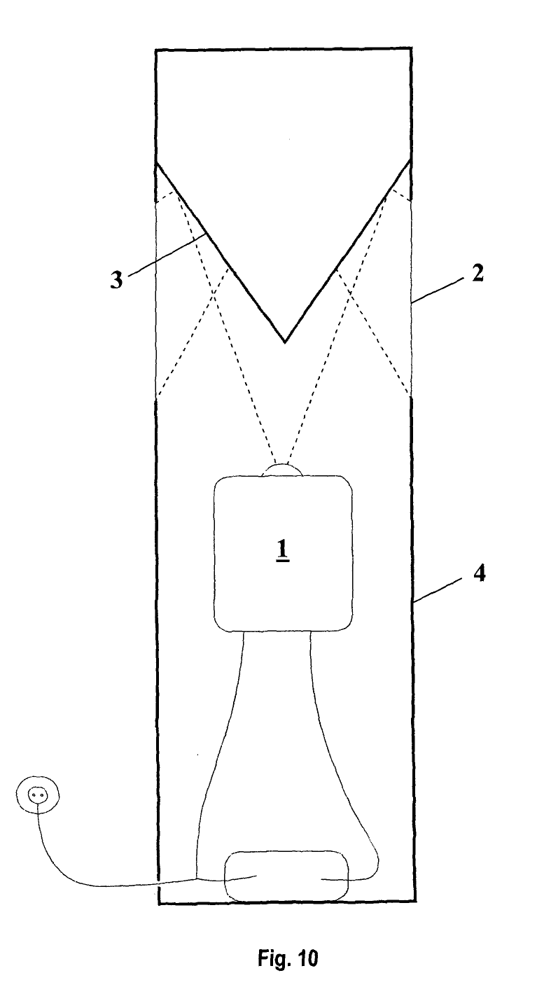

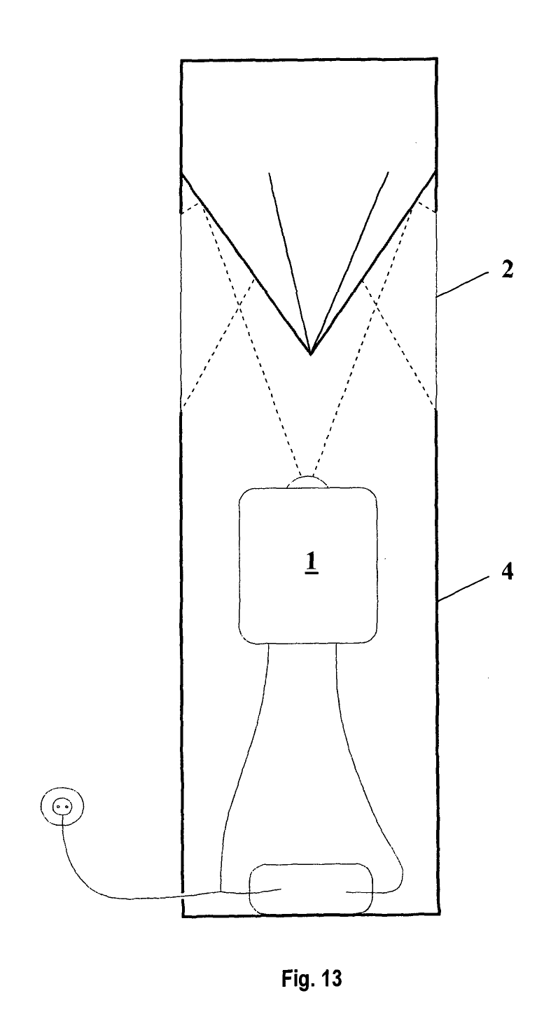

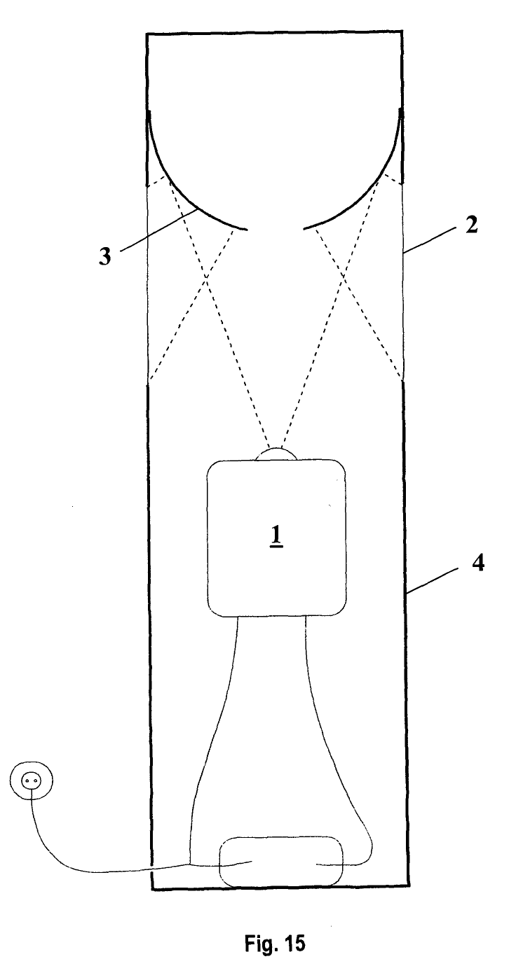

The mirror 3 can be designed spherical (spherical mirror), parabolic, hyperbolic, or otherwise curved in two spatial dimensions. It may, for example, also be elliptical or present the shape of a cone (see FIGS. 10, 11, 12). This depends on the desired dimensions of the height of the projection surface 2 and the distance of the mirror 3 from the projection means 1 on the one hand, and on the other hand on the shape of the projection surface 2 and the desired distorted or undistorted presentation. The mirror 3 may be configured as a hemisphere or as a sphere sector. In addition, it can be seen from FIG. 1 and the indicated light paths, that the vertex of the mirror 3 that faces the projection means 1 is unused for the screen presentation and may be configured as a hole or as translucent (see FIG. 15). This has the advantage that no light from this location on the mirror is reflected into the interior of the pillar 4 causing interfering scattered light effects there. In addition, an open mirror and thus being configured as a ring surface, has the advantage to be producible more easily and therefore to be more economical to purchase. Alternatively, according to FIG. 13, the mirror may be configured pyramidal. In this case, the mirror comprises plane surface elements that form edges at their joint. During the digital projection, optical distortion effects and projection gaps or overlaps, respectively, resulting therefrom have to be considered, particularly in the distortion of content to be projected, which is rectified by the reflection on the mirror 3.

The projection surface 2 is a back projection foil. Commercially available back projection foils are made of polyvinylchloride (PVC), for example.

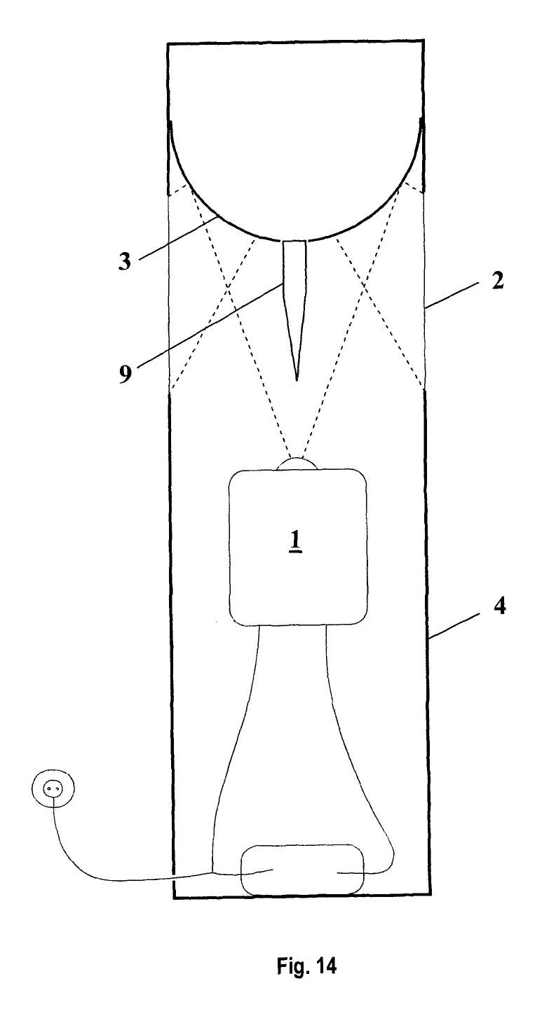

According to FIG. 14, a diaphragm element 9 is located in the area of the vertex of the mirror 3. The diaphragm element 9 may present the form of a cylinder. Although the cross section of the diaphragm element 9 is small in comparison with the cross section of the projection surface 2, the surprising effect occurs that backscattered light from the inner side of the projection surface 2 is shielded from the opposite inner side of the projection surface 2. In this way, disruptive scattered light within the pillar 4 is effectively reduced.

The screen in FIG. 1 is located within a pillar 4, in particular an advertising pillar, which has a connector 6 to an external power source. The pillar may have speakers for audio playback. Preferably, the speakers are located in the upper part of an erected pillar 4, since this comes closest to the natural auditory sense of the viewers of the screen. It is appreciated that the outer surface of the pillar 4 is configured sound permeable in the relevant places.

Still photographs, moving images, films etc. may be presented. If the formats of the presentations are present digitally, they may be distorted by a program in a digital way, so that they appear rectified after reflection by the mirror 3 and arriving at the projection surface 2. The displayed motifs may be 360° views or limited and juxtaposed views (so called split-screen view).

In FIG. 2 there are shown two opposing screens. Again located in a pillar 4, the proportion of the pillar surface that is occupied by a projection surface 2 or 2′ increases. To this end, a mirror 3′ is located conversely along the optical axis opposite a second projection means 1′, which is also located on the optical axis but conversely aligned. Both projection surfaces 2 and 2′ are spaced apart from each other by a peripherally located band 8.

According to FIG. 3, two screens are located such that the optical relationships between the components correspond those from the embodiment in FIG. 2, the spatial distances however, are different. The specified circumstance is utilized, that the vertex areas of the mirrors 3 and 3′ are optically unused and may be configured as holes or translucent. Also, in FIG. 3, the screens are spaced apart by a band 8. However, the distance height may be reduced to zero so that the viewer has the impression that he/she is standing in front of one single screen. To this end, the content to be projected is output split by a computer to both projection means 1 and 1′.

In FIG. 4, a screen located in a pillar 4 can be seen, the projection means 1 of which consists of two projectors. They are aligned along the optical axis in such a way that they each illuminate somewhat more than half a side of the mirror 3. Thus, an area arises on the mirror 3 and the projection surface 2 in which the presentations of both projectors overlap. In this area, both projectors show the same presentations with minimized intensity (soft-edge technology) in order to minimize breaks, unsharpnesses or differences in brightness in the entire presentation.

It is an advantage of this embodiment that the screen has an improved brightness and a higher image resolution than a screen having only one projector.

In a particularly advantageous embodiment, the mirror 3 is configured open in its vertex and has a diaphragm element 9 according to FIG. 14. When using two projectors, a surprisingly constructive advantage is achieved in that cables for driving the speaker cabinets may be routed between the projectors through the diaphragm element 9 and through the opening in the mirror 3 to the speakers. Thus a multi-media image on the screen that comes closest to the natural viewing and listening habits is possible without the necessary cables being located in the optical path from the projection means 1 to the viewer.

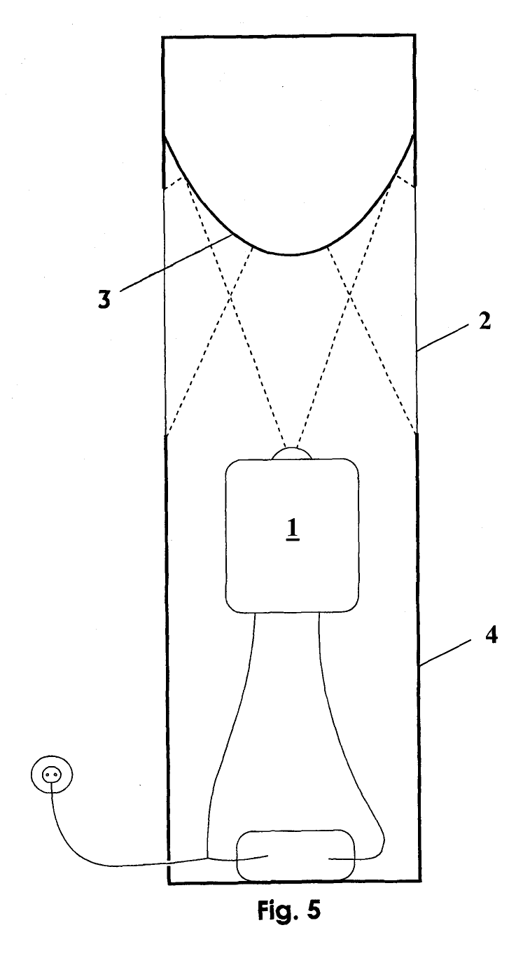

According to FIG. 5, the mirror 3 may also be designed as a parabolic mirror. Thereby the presentation will become sharper on the one hand and on the other hand a larger screen height may be illuminated. Spherical mirrors have the advantage of being more cost-efficient than the parabolic ones.

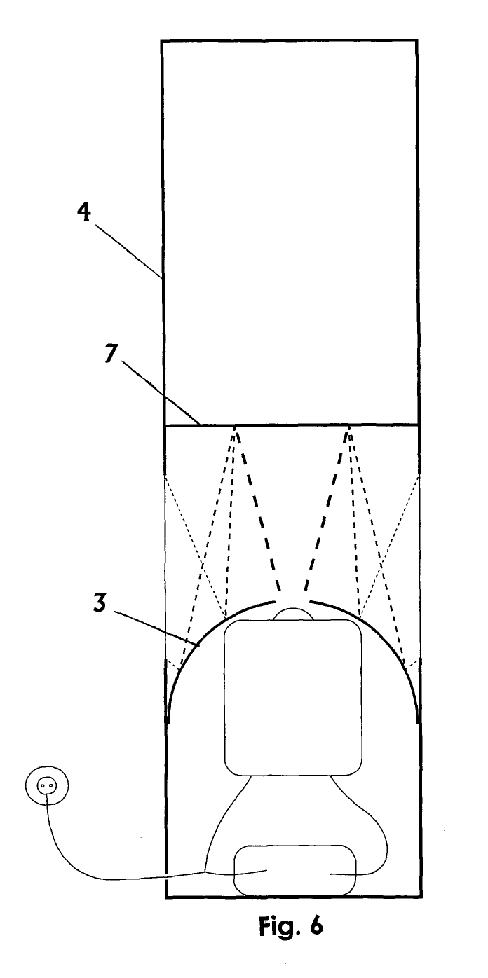

In FIG. 6, a plane mirror 7 is situated optically between the projection means 1 and the mirror 3. Thereby the mirror 3 has to be aligned reversed relative to the arrangements of the previously described embodiments. Correspondingly, the presentation of the projection is mirrored and has possibly to be digitally recalculated by a computer program. In this embodiment the screen is more compact and leaves more free space in the pillar 4, for example.

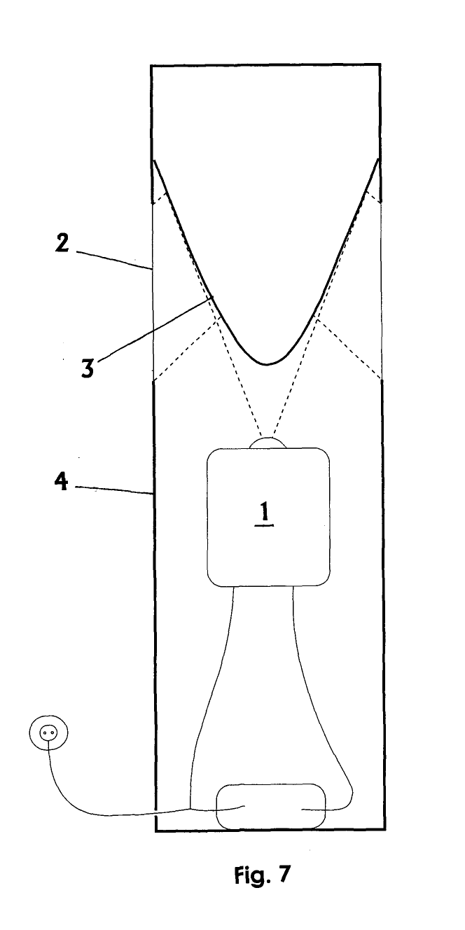

According to FIG. 7, the mirror 3 may be designed as a hyperbolic mirror.

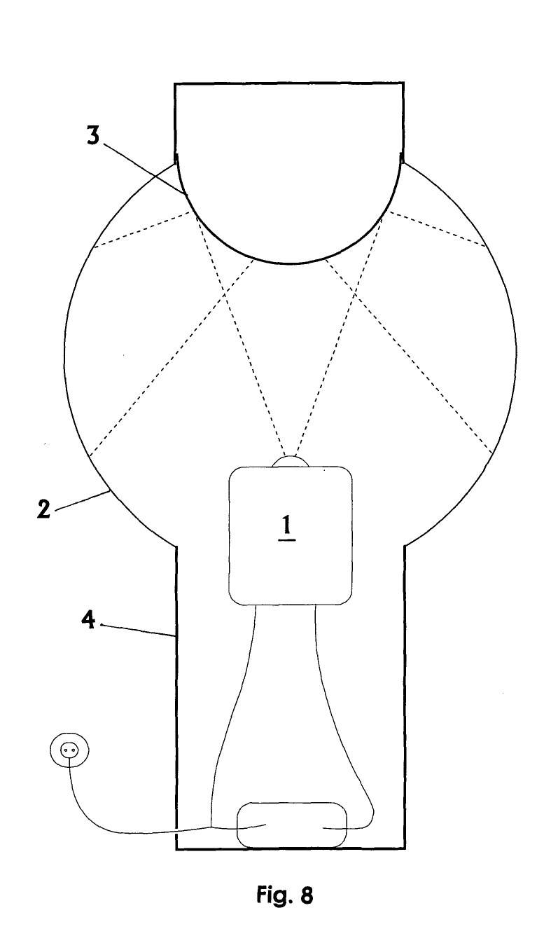

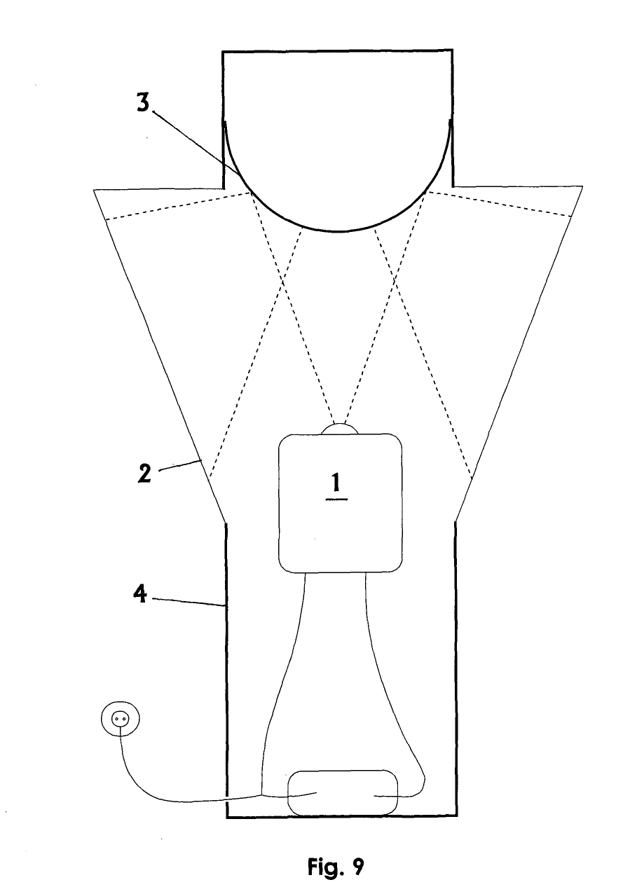

In FIGS. 8 and 9, the screens are depicted in pillars 4, which form rotation bodies that deviate from the cylindrical form. FIG. 8 shows an essentially spherical screen; FIG. 9 presents one that is essentially cone shaped. The rectification of the information projected onto the screen is performed computationally.

It is appreciated that within the scope of the inventive idea the described exemplary embodiments may be modified in different ways, e.g. regarding the display angle of the screen, which may be smaller than 360°, the mirror curvature, the design of the projection means or the shape of the body which the projection surface forms.

1. A screen having a display angle of 360°, wherein in the light path of a projection means and in the area of the central axis of a projection surface closed about 360° formed by a pillar, a mirror is located, wherein the mirror is configured as a spherical mirror.

2. A screen having a display angle of 360°, wherein in the light path of a projection means and in the area of the central axis of a projection surface closed about 360° formed by a pillar, a mirror is located, the mirror surface of which is the surface of a curve rotating about the axis located in the light path of the projection means, wherein the curve and the distance of the projection means to the mirror are chosen in such a way that the screen upon projection of the mirror is illuminated at an angle of 360°.

3. A screen according to claim 1, wherein the surface of the mirror is essentially parabolic, hyperbolic or elliptic.

4. A screen according to claim 1, wherein the mirror is open in the area of the axis of rotation.

5. A screen according to claim 1, wherein between the projection means and the mirror a diaphragm element is located in the light path.

6. A screen according to claim 5, wherein the diaphragm element is configured as a cable duct.

7. A screen according to claim 1, wherein the projection means is at least one projector.

8. A screen according to claim 1, wherein the pillar and the projection surface are configured essentially cylindrically or ellipsoidally.

9. A screen according to claim 1, wherein the projection surface is a back projection foil, which is made from polyvinylchloride, for example.

10. A screen according to claim 1, wherein an essentially plane mirror is located in the light path of the projection means and the mirror is located such that the light reflected from the plane mirror is reflectable onto the projection surface again.

11. A screen according to claim 1, wherein the projection means is driveable by means of a computer or a commercially available playback device.

12. A screen according to claim 11, wherein a program for processing the image data is installed in the computer through which the display distorted by the mirror curvature is rectifiable.

13. A screen according to claim 1, wherein the projection surface is essentially spherical or cone shaped.

14. A screen according to claim 1, wherein outside of and parallel to the projection surface a protective glass, e. g. made of acrylic glass is located.

15. A pillar, in particular an advertising pillar, having a screen according to claim 6, wherein the projection means includes two projectors and in the area viewed from the projection means speakers for audio playback are located behind the mirror, wherein cables for driving the speakers are routed in the central axis of the pillar and in the diaphragm element.

16. A pillar, in particular an advertising pillar, having a screen according to claim 1.

17. A pillar according to claim 16, wherein the pillar surfaces left clear from the projection surface are equipped for receiving posters.

18. A pillar according to claim 17, wherein the pillar surfaces serving to receive posters comprise a background illumination.

19. A pillar according to claim 16, wherein speakers for audio playback are located in or on it.

20. A pillar according to claim 15, wherein it comprises a second screen having
a display angle of 360°, wherein in the light path of a projection means and in the area of the central axis of a projection surface closed about 360° formed by a pillar, mirror is located, wherein the mirror is configured as a spherical mirror,
wherein the associated projection means and the associated mirror are arranged in opposition to those of the first screen.

21. A pillar, in particular an advertising pillar, having a cylindrical pillar body comprising a projection surface for messages, wherein a projection means is provided in the pillar body, wherein in the light path of it and in the area of the central axis of the projection surface closed about 360° a mirror is located.
